(19) United States
(12) Patent Application Publication
(10) Pub. No.: US 2012/0005038 A1
(43) Pub. Date: Jan. 5, 2012

(54) System And Method For PCI-Compliant Transactions

(76) Inventor: Saurabh Soman, Thornhill (CA)

(21) Appl. No.: 13/175,776

(22) Filed: Jul. 1, 2011

Related U.S. Application Data
(60) Provisional application No. 61/361,240, filed on Jul. 2, 2010.
(60) Provisional application No. 61/375,150, filed on Aug. 19, 2010.
(60) Provisional application No. 61/389,621, filed on Oct. 4, 2010.

(51) Int. Cl. G06Q 30/00

(52) U.S. Cl. 705/26.41

(57) ABSTRACT

A hosted PCI system for isolating a merchant ecommerce system from credit card data within the scope of PCI standards comprises a server responsive to communication from a purchaser's browser, redirected by the merchant system, for providing the purchaser's browser with a check-out page obtained from the merchant system that solicits the purchaser's actual credit card number. The hosted PCI system receives the purchaser's actual credit card number without exposing it to the merchant system, converts it to a mapped credit card which the merchant system can store without PCI compliance.

When the hosted PCI system thereafter receives payment amount information with the mapped credit card number, it derives the actual credit card number from the mapped credit card number, sends the actual credit card number and payment amount information to a payment gateway on behalf of the merchant, and communicates the payment gateway's response to the merchant system.

### FIELD OF THE INVENTION

This invention relates to systems and methods for approving credit card transactions.

### BACKGROUND OF THE INVENTION

Electronic commerce, commonly known as e-commerce, consists of the purchasing and selling of products or services over electronic systems such as the Internet and other computer networks, and includes paying for those products and services. Accordingly, data pertaining to the purchaser's credit card information must be transmitted during the transaction to facilitate sales transactions. The electronic transmission of credit card information can happen even when the purchaser is ordering telephonically, since merchant's customer representative is typically entering the information into an electronic system that communicates over the Internet or other electronic network with the credit card processing entity.

A payment gateway is an e-commerce application service provider that authorizes payments to e-businesses and online retailers, and facilitates the transfer of information between a payment portal (such as a website, mobile phone or interactive voice service) and the card-issuing bank. When a customer orders a product from a merchant, the payment gateway performs a variety of tasks to process the transaction:
1. A customer places order on website by entering credit card information and pressing a ‘Submit Order’ button (or telephonically entering credit card information using a telephone keypad and/or merchant's customer representative).
2. If the order is entered by the customer a website, the customer's web browser encrypts the information to be sent between the browser and the merchant's webserver, and the information is transmitted via Secure Socket Layer (“SSL”) encryption.
3. The merchant then forwards the transaction details to their payment gateway. This is another SSL encrypted connection to the payment server hosted by the payment gateway.
4. The payment gateway forwards the transaction information to the payment processor used by the merchant's acquiring bank.
5. The payment processor forwards the transaction information to the card association (e.g., Visa/MasterCard) which, in turn, routes the transaction to the correct card issuing bank (or, in the case of American Express and Discover, provides a response of approval or decline to the payment gateway.)
6. The credit card issuing bank receives the authorization request and sends a response back to the processor (via the same process as the request for authorization) with a response code.
7. The processor forwards the response to the payment gateway.
8. The payment gateway receives the response, and forwards it on to the web site (or whatever interface was used to process the payment) where it is interpreted as a relevant response and relayed to the cardholder and merchant.

Examples of currently known payment gateway providers are: Cybersource, Paypal Payflow Pro, Moneris, and Authorize.Net

Since 2004, the payment card industry has adopted the PCI standard. This standard governs security best practices, procedures and policies for payment processors, payment providers and merchants utilizing credit card information.

The PCI standard was developed to ensure that the industry as a whole adopts a single view of credit card security and that all actors (payment processors, merchants, services providers) adopted the required security measures to ensure the safety and security of card holder information. Merchants generally wish to avoid the expense and burden of becoming PCI compliant, as well as the liability that can arise from misuse and hacking of such information after it is entrusted to the merchant.

Two methods for complying with the PCI standards have accordingly evolved: the so-called “vault” (also called “payment tokenization”), and the hosted check-out page. The following scenario (use-case) describes a credit card vault/tokenization solution:
Consumer visits a merchant website and decides to make a purchase
Merchant website takes the consumers credit card details through a secure payment page hosted on the merchant's website.
The Merchant's ecommerce software then communicates with the “vault” that stores the credit card and returns a token representing the actual credit card number.
The Merchant does not store the credit card in the ecommerce software database, thus avoiding security storage requirements set forth by the PCI DSS standard.

Some vault/tokenization solutions currently available include a payment management system offered by CyberSource Corp (Mountain View, Calif.), and a payment management system offered by Verifi, Inc. (Los Angeles, Calif.

The issue with the vault solution is that the Merchant must still initially accept the credit card information from the customer. This exposes the Merchant system to sensitive information causing the Merchant's information systems to be “in scope”; i.e., within the scope of the PCI standard. Potentially in-scope systems include: firewall, network switches, IDS/IPS (Intrusion Detection and Prevention), Application Servers, Web Servers, Load Balancer, Application Firewall, Ecommerce Application and other components that might touch credit card information. By our estimate, the implementation of the vault/tokenization solution by a merchant only covers 25% of the overall PCI DSS standard, thus leaving 75% of the standard to be implemented by the Merchant. One of the consequences of using the vault solution is that the merchant must still incur to cost of becoming PCI certified, and the complexity and work involved approaches that of simply not using a vault solution.

The second methodology available in the market today that tries to address the PCI compliance issue faced by the merchant is known as “hosted checkout” pages. The following scenario (use-case) describes a hosted checkout page solution:
Consumer visits a merchant website and decides to make a purchase
Merchant website takes the consumer through the shopping cart and checkout process, up until the point where credit card information is required.
At that point, the merchant website redirects the consumer to a 3^{rd} party checkout page provider and includes some information about the order.
The 3^{rd} party checkout page provider displays a simple page requesting credit card information
If the order and credit card details are processed successfully the 3^{rd} party checkout page provider redirects the customer back to the Merchant website with successful transaction details related to the order.

Currently available hosted checkout page solutions include a payment management system offered by PayPal (San Jose, Calif.) and a payment management system offered by Verifi, Inc. (Los Angeles, Calif.)

Existing hosted payment page solutions provide merchants with a simple path to PCI DSS compliance, but lack the flexibility required to fully customize and configure the following elements of the checkout process:
Checkout success and error flow
Display rules
Business rules including discount, store credit, loyalty credits and other merchant specific elements

### SUMMARY

The hosted PCI system herein places itself between the merchant and the payment gateway when a customer a customer of the merchant wishes to place an on-line order or a telephonic order. In both cases, the hosted PCI system shields the merchant from information that would subject the merchant to PCI compliance, while giving the merchant the flexibility required to customize and configure the checkout process.

The hosted PCI system and method described herein allows merchants to completely eliminate the need to adopt complex PCI DSS requirements by never transmitting or storing customer credit card information. In the course of engaging in an online purchase at a merchant's website, the customer is directed to the hosted PCI system by the merchant's ecommerce system so that the customer's credit card information can be entered into the hosted PCI system rather than the merchant's ecommerce system. The webpage presented to the customer for the entry of the credit card information is, however, obtained by the hosted PCI system from the merchant's system so that the merchant has control over the look and feel of the presented webpage. (Naturally, the merchant can use a third party's system or a separate server to store the acquired page, and that system or server is included within the scope of “merchant's system”.)

The customer accordingly submits the credit card information to the hosted PCI system page, which is displayed to the customer on behalf of the merchant. The credit card information is preferably checked, verified and encrypted by the hosted PCI system, which then submits the complete order request back to the merchant system, which accepts the order as it would a typical credit card transaction.

However, the customer's actual credit card number is not part of that submission back to the merchant. Instead, the hosted PCI system herein only passes back a representation of the credit card number (hereinafter, a “mapped credit card”). The merchant's ecommerce system then submits the mapped credit card number back to the hosted PCI system for credit card authorization or sale transaction. The hosted PCI system performs a lookup of the real credit card information based on the mapped credit card number the merchant system provides for authorization or sale. Once the credit card number is retrieved, it is un-encrypted and passed to the payment gateway previously selected by the merchant.

The payment gateway then sends back the response of the authorization or sale transaction to the hosted PCI system which transparently forwards the response to the merchant system, without revealing the actual credit card number details. The merchant system can then analyze the response from the hosted PCI system and applies application logic for processing a successful or failed order attempt.

Thus, the merchant's ecommerce account never receives or stores credit card information that would render the merchant's system susceptible to PCI-compliancy. At most, the merchant can store the mapped credit card number which, even if obtained without authorization, is useless outside the hosted PCI system.

In accordance with another aspect of the hosted PCI system, telephonic orders by a customer can be accommodated as well. When a customer places a telephone call to the merchant's call center to place order for product or service, a customer service representative (CSR) transfers the customer to a secure phone line for credit card processing. The CSR opens a hosted PCI system portal to obtain a unique session ID for the transaction and opens a secure telephone line for the customer. The hosted PCI system uses the phone connection to prompt the call center employee for the session ID displayed by the portal and the customer for credit card information. The hosted PCI system validates the credit card number through a Lunh check (or other checksum formula) and generates a mapped credit card number for use by the CSR to complete the transaction, with the process and host PCI system thereafter functioning in the manner described above with respect to on-line transactions. Accordingly, the CSR does not see the actual credit card number, and the merchant remains outside the scope of required PCI compliance.

In accordance with another aspect of the invention, a preferred method and system for generating a mapped credit card number creates a token that replaces a plurality of the actual credit card number's numerals with assigned digits that preferably result in a mapped credit card number that fails a security check.

These and further details of the invention will be apparent to those of ordinary skill in the art from reading a detailed description of the preferred embodiment described below, of which the drawing forms a part.

### DESCRIPTION OF THE DRAWING

In the drawing,

FIG. 1 is an illustration of a final checkout page displayed on a consumer's monitor by the consumer's browser in accordance with the invention;

FIG. 2 is detailed view of the final checkout page displayed on a consumer's monitor by the consumer's browser in accordance with the invention;

FIG. 3 is an illustration of detailed view of the SSL security certificate displayed on a consumer's monitor by the consumer's browser in accordance with the invention;

FIG. 4 is a block diagram illustration of the processing steps performed on the consumer's credit card number by a hosted PCI system constructed in accordance with the invention;

FIG. 5 is a schematic illustration of a hosted PCI server operating within an ecommerce network in accordance with the invention;

FIG. 6 illustrates a merchant's checkout page displaying a partially masked mapped credit card number to the consumer in accordance with the invention;

FIG. 7 is a schematic illustration of hosted PCI server operating within an ecommerce network in accordance with the invention when a previously processed credit card is used for a subsequent order;

FIG. 8 is an illustration of a preferred page presented to an authorized employee of a merchant prior to enabling the employee to access “in scope” credit card information;

FIG. 9 an illustration of a preferred page presented to an authorized employee of a merchant presenting “in scope” credit card information;

FIG. 10 is a schematic illustration of hosted PCI server operating within an ecommerce network in accordance with the invention when a telephonic order is placed by the customer to a merchant.

### DETAILED DESCRIPTION OF THE PREFERRED EMBODIMENT

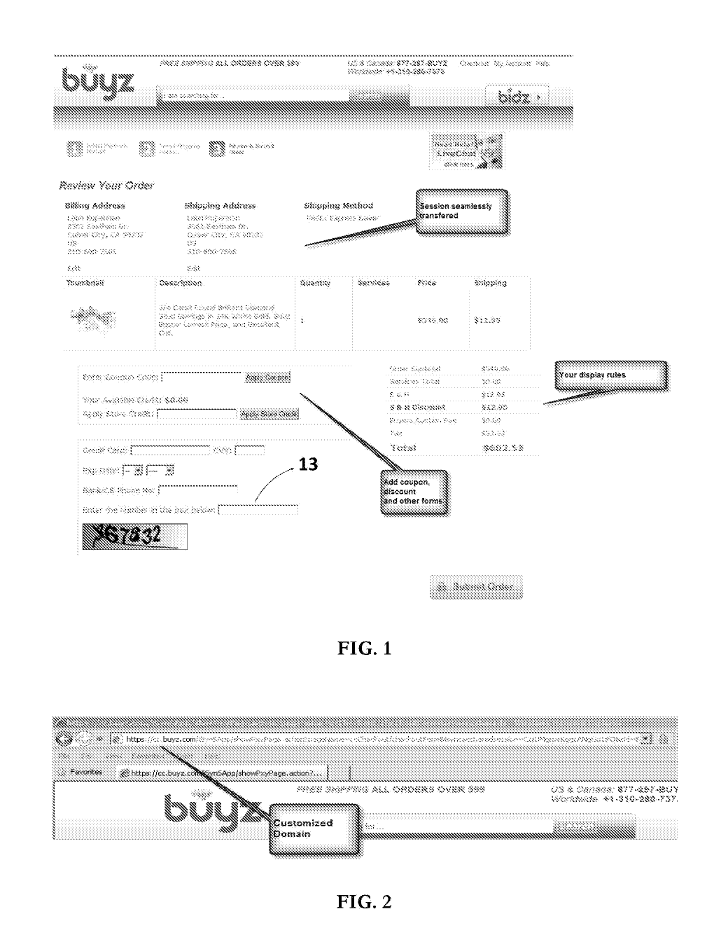

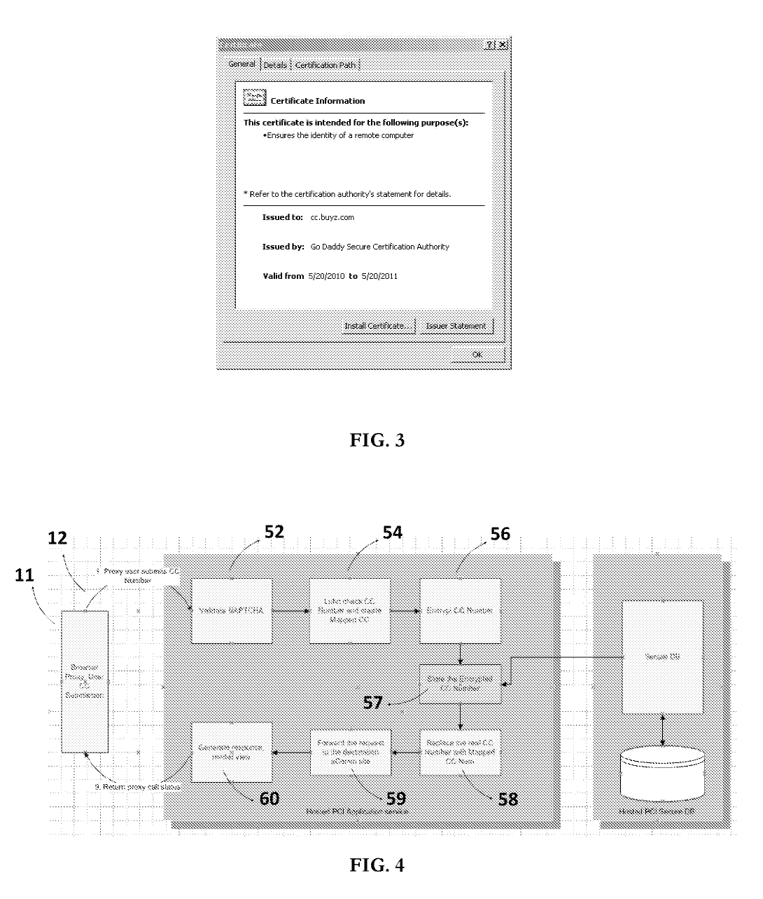

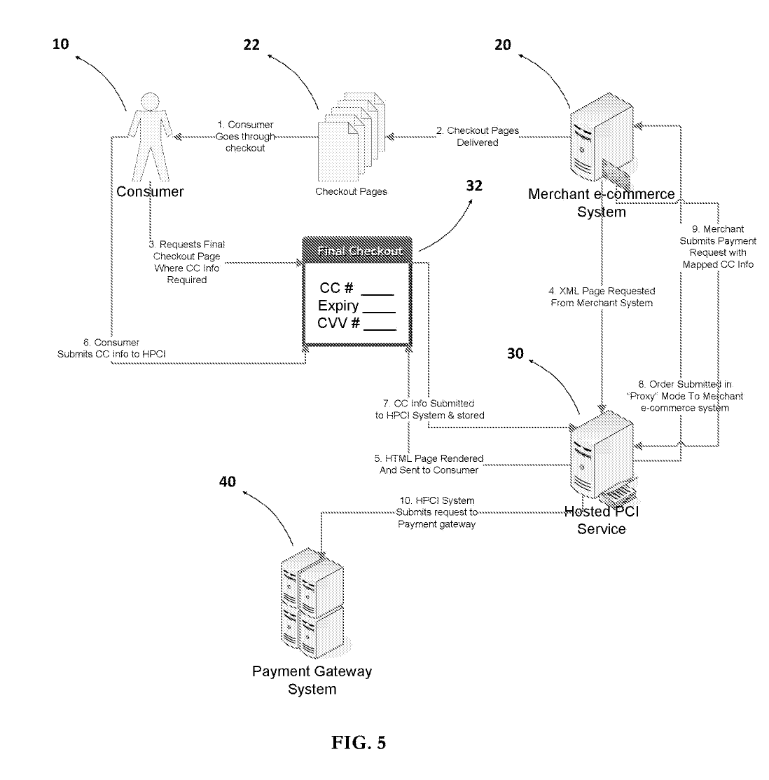

FIG. 5 is a schematic illustration depicting a network configured in accordance with the invention.
A consumer 10 visits a merchant's website generated by a merchant's e-commerce system 20 and decides to make a purchase.
The merchant website takes the consumer through the various checkout pages 22 desired by the merchant (e.g., the “shopping cart” and “checkout” processes), up until the point at which credit card information is required.
At that point, the merchant website redirects the consumer to the hosted PCI system 30, where a final checkout page 32 is presented to the consumer.
The Hosted PCI system makes a “proxy” call to the merchant system to obtain a version of the final checkout page, preferably rendered however in XML format, rather than in HTML. An example of a final checkout page for a merchant named “buyz.com” is illustrated in FIG. 1. The final checkout page has the look and feel associated with the merchant because the merchant controls its layout, its coloring, its script style and location, etc. Information previously entered by the consumer appears on the page, adding to the perception of continuity in the mind of the consumer.
   The term “proxy call” refers to the hosted PCI system making an HTTP or HTTPS request to the original merchant ecommerce system, on behalf of the consumer. From the merchant's ecommerce system's perspective, it seems as if the consumer's browser is making the request; however it is actually the hosted PCI system proxy-ing the call from the consumer's browser.
   XML Format is preferably used rather than HTML because XML is a much better format to communicate system-to-system. The XML Tags used in the communication between the hosted PCI system and the merchant ecommerce system are pre-determined at the time of setup by the merchant, and therefore the tags can easily be interpreted by the hosted PCI system and checkout data can be rendered on the consumer's browser according to pre-determined display rules previously agreed to by the merchant and the operator of the hosted PCI system
The hosted PCI system transforms the merchant-generated XML and presents a visual representation of the final checkout page. (FIG. 1) The XML to HTML mapping and presentation rules are predetermined during setup of the hosted PCI solution.
   The field/tag mappings and display rules are preferably communicated to the hosted PCI system during the setup of the solution so that the final rendering appears exactly as the merchant intended. There are no set fields and/or tags required by the hosted PCI system. The mapping and display rules for the provided fields are entirely determined by the merchants business and usability requirements.
   Prior to mapping deployment, a manual review of the mapping and display rules can be performed by a security engineer to check for standard potential vulnerabilities as is required by the PCI DSS standard.
Both the checkout domain and SSL security certificate are preferably owned by the merchant and presented as such to the consumer. As illustrated in FIG. 2, the merchant's domain name “buyz.com” appears as the domain address on the checkout page, and the corresponding SSL certificate displays the name of the merchant as well as shown in FIG. 3.
The customer submits credit the credit card information to the final check-out page transmitted by the hosted PCI system on behalf of the merchant.
The credit card information sent by the consumer to the hosted PCI system preferably goes through the process depicted in FIG. 4 to be checked, verified and encrypted. An optional “CAPTCHA” test is first applied at 52 to the data 12 transmitted by the consumer's browser 11. CAPTCHA involves a challenge-response test used to ensure that the data is generated by a person. Referring briefly to FIG. 1, the consumer has been prompted to enter CAPTCHA data (i.e., the numeral 367832) into field 13 of the displayed page. If the test is passed, the credit card number is Luhn-checked and, if valid, converted to a mapped credit card number at 54. The actual credit card number is then encrypted at 56 and stored within the hosted PCI system at 57.
Once the actual credit card number is encrypted in the hosted PCI system, the hosted PCI system submits the complete order request in “proxy” mode back to the merchant system, as at 58-60. The merchant system cannot distinguish the request as coming from the hosted PCI system or the actual consumer's web browser. The merchant system accepts the order as it would a typical credit card transaction. However, the hosted PCI system is only passing a representation of the consumer's credit card number, not the actual credit card number, to the merchant system, thus keeping the merchant system outside the scope of the PCI standard.
   The merchants ecommerce system then submits the mapped credit card number back to the hosted PCI system for credit card authorization or sale transaction.
      The hosted PCI system performs a lookup of the actual credit card information, based on the mapped credit card number the merchant system provides, for authorization or sale.
      Once the actual credit card number is retrieved, it is un-encrypted and passed by the hosted PCI system to the payment gateway previously selected by the merchant. The payment gateway provider can be any available gateway that has private or public payment processing interfaces. Examples are: Cybersource, Paypal Payflow Pro, Moneris, Authorize.Net
      The payment gateway then sends back the response of the authorization or sale transaction to the hosted PCI system, which transparently forwards the response to the merchant system, without revealing the actual credit card number details.
      The merchant system can then analyze the response from the hosted PCI system, and applies application logic for processing a successful or failed order attempt.

It may be noted that the hosted PCI system is inserted between the merchant system and the payment gateway, thereby shielding the merchant from “in-scope” credit card information and has, in accordance with the preferred embodiment, operated in “proxy” mode. (It is recognized that other modes performing equivalent functions may be utilized now or in the future that enables a hosted PCI system to perform the same shielding functions, and it is intended that those other modes be deemed equivalents if they enable the intervening system to accomplish the same task.)

Benefits of “Proxy Mode” Payment Processing within the HOSTED PCI System

When using “proxy mode” processing the hosted PCI system can present the payment gateway API (Application Programming Interface) directly to the merchant, without the need for the merchant e-commerce system to submit actual credit card information to the gateway that the merchant has selected. The merchant e-commerce system instead uses the mapped credit card number supplied by the hosted PCI system.

Since each payment gateway API is different and has different capabilities exposed to the merchant, the preferred hosted PCI system can deliver the gateway API functionality unique to the merchant selected gateway when operating in proxy mode. Presently, this type of transparency cannot be delivered without using “proxy mode” processing and is accordingly a preferred feature. Future advances in this technology may provide alternatives to “proxy mode” in this regard, without falling outside the scope of this invention.

### Storing Credit Card for Future Checkout

In many cases the merchant e-commerce system will provide the ability for the consumer to enter the credit card information to the merchant website only one time (on first checkout, for example) and then use the submitted credit card for subsequent orders.

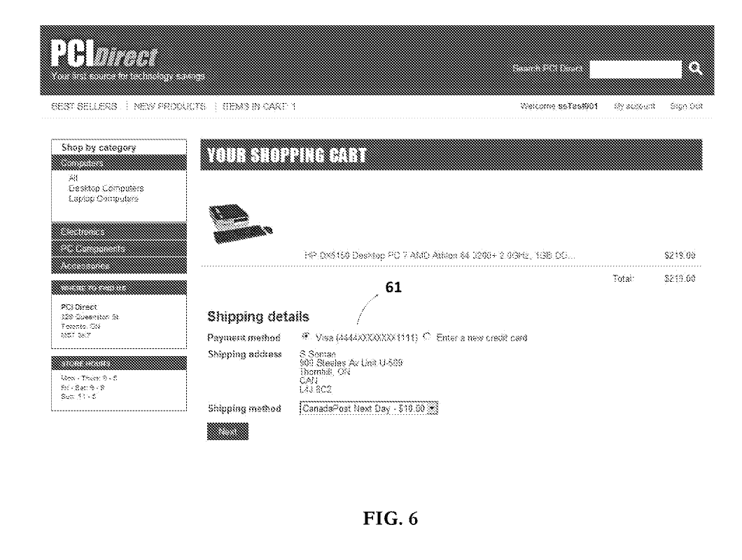

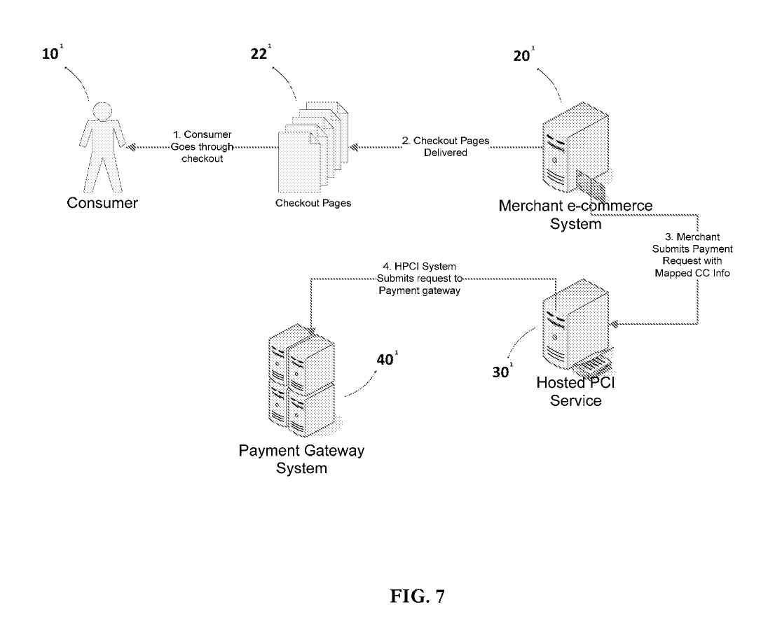

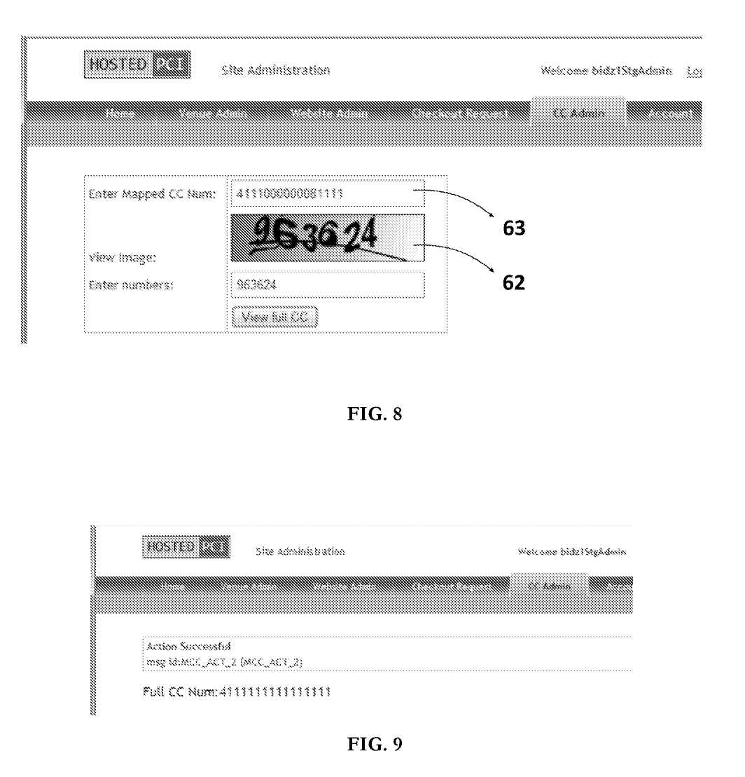

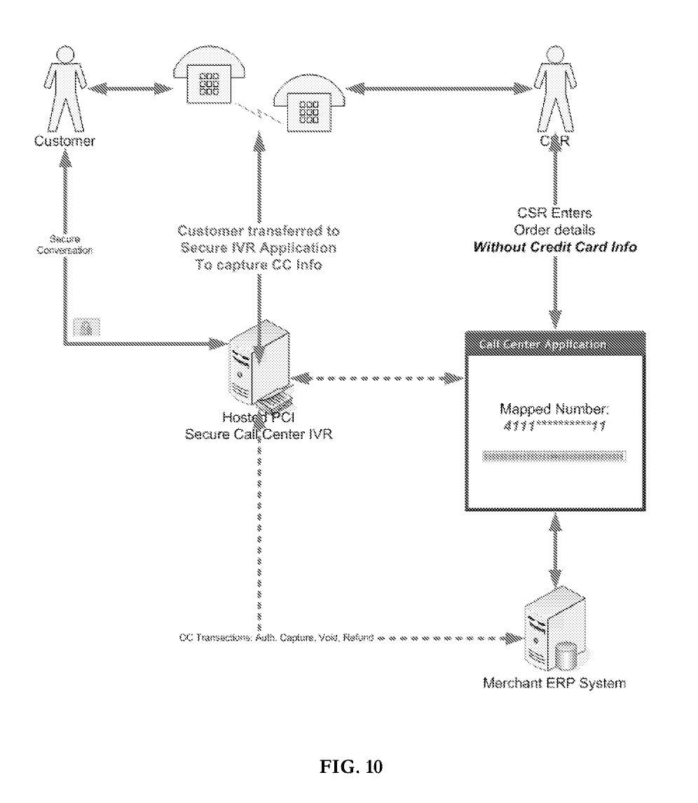

Under such circumstances the preferred hosted PCI system and methodology operates as illustrated in FIG. 8, as follows:
Consumer 10′ visits a merchant website generated by the merchant's e-commerce system 20′ and decides to make a purchase
The consumer 10′ has previously shopped at the merchant website and already has a mapped credit card number (typically the first four and last four digits of the consumer's credit card match the mapped number on file with the merchant) stored on file with the merchant, through the prior processing by the hosted PCI system during that prior transaction
The merchant ecommerce system 20′ takes the consumer through the shopping cart and presents a shipping address and masked credit card number that has, for example, the same first 4 digits and same last 4 digits as the customer's actual credit card that was entered during said prior transaction. (FIG. 6)
   Other sets of digits from the credit card may be used instead, without falling outside the scope of this invention; currently, however, the first four and last four digits are the preferred convention.
The mapped credit card is retrieved directly from the merchant's e-commerce system, since the merchant could store the mapped credit card number without the burden of PCI compliance. Accordingly, the initial redirection of the consumer to the hosted PCI system is not required because the mapped credit card number can be stored in the merchant system, retrieved by the merchant system, and displayed to the consumer for (either alone or among a plurality of alternatively selectable mapped numbers representing a plurality of credit cards the consumer has used in prior transactions with the merchant). Before displaying the mapped credit card number, only the 8 middle digits need be masked with an asterisk (*) or other masking character if the first four and last four digits are to be displayed to the consumer for identification and/or confirmation purposes. FIG. 6 illustrates a merchant's checkout page displaying (at 61) a partially masked mapped credit card number to the consumer.
The customer selects the desired credit card from the merchant shopping cart.
The merchant e-commerce system 20′ submits the order information with the mapped credit card information to the hosted PCI system 30′ through the hosted PCI API (“Application Programming Interface”).
The hosted PCI system 30′ performs a lookup of the real credit card information based on the mapped credit card number the merchant system provided for authorization or sale.
Once the actual credit card number is retrieved, it is un-encrypted by the hosted PCI system and passed to the payment gateway system 40′ previously selected by the merchant. The payment gateway provider could be any available gateway that has private or public payment processing interfaces. Examples include: Cybersource, Paypal Payflow Pro, Moneris, Authorize.Net
The payment gateway system 40′ then sends back the response of the authorization or sale transaction to the hosted PCI system 30′ which transparently forwards the response to the merchant system 20′, without revealing the actual credit card number details.
The merchant system 20′ can then analyze the response from the hosted PCI system and applies application logic for processing a successful or failed order attempt.

It can be noted that the consumer never had to visit a hosted PCI page to enter credit card information. Since the merchant e-commerce system has already stored the mapped credit card number associated with the real credit card number, only the mapped credit card number has to be submitted to the hosted PCI system for payment processing. Moreover, only the masked portion of the mapped credit card number (i.e., the portion that differentiates the actual and mapped numbers, and hereinafter referred to as the “token”) needs to be sent to the hosted PCI system.

### Accessing Credit Card for Fraud Investigation

In some cases, the merchant may require actual credit card information in order to communicate with the acquiring bank or other fraud filtering service. In order to permit the actual credit card information to be accessed under such circumstances, a customer portal can be provided to the hosted PCI system, if needed, that allows credit card retrieval.

The preferred operation of the system under such circumstances is as follows:
The consumer completed an order through the merchant website/hosted PCI system, and the credit card used for the order is stored within the hosted PCI system “vault”.
The merchant now requires the actual credit card number, tied to the particular order and mapped (i.e., “tokenized”) card for specific business reasons: fraud filtering, investigation, etc.
An authorized employee of the merchant logs onto the hosted PCI system, and selects a credit card administration feature from the menu.
The hosted PCI system prompts the authorized employee to enter a CAPTCHA code, and the mapped (tokenized) credit card number, as respectively depicted at 62 and 63 in FIG. 8.
If a valid mapped credit card number is entered and the CAPTCHA is validated, the preferred hosted PCI system presents the authorized employee with a valid un-mapped and unencrypted original credit card number, as illustrated in FIG. 9). It should be noted that the computer where the merchant retrieves the actual credit card is consequently “in-scope” for PCI, but this does not affect the entire ecommerce system of the merchant if configured correctly to isolate said computer from said ecommerce system.

### Securing Credit Card Information Over a Telephone Session

Many merchants utilize centralized call center facilities to accept calls from customers. Many times, customers are calling to place direct orders over the telephone and will often present sensitive credit card information to the customer service representative (CSR). The following system configuration and method allow human interaction between a customer and a CSR:
Customer 80 calls merchant call center to place order for product or service
CSR 82 takes order details up to the point of credit card information
CSR indicates to customer that they will be connected to a secure phone line for credit card processing.
CSR opens a hosted PCI system portal and initiates a phone session from within the hosted PCI system.
The hosted PCI system generates a unique session ID for the transaction and provides that session ID to the CSR through the hosted PCI portal.
The CSR then opens a new phone line and dials (or uses a quick dial button) a hosted PCI system phone number.
The hosted PCI system uses the phone connection to prompt the call center employee for their user ID and password, and for the session ID displayed by the hosted PCI portal
The CSR then joins or connects the customer call with the hosted PCI call, using standard call-conferencing functionality available with most telephone systems.
The hosted PCI system prompts the customer to enter such data as the credit card number, the credit card verification number located on the back of the card and the credit card expiration date. Other security information, such as billing zip code, can be requested as well.
The hosted PCI system validates the credit card number through a Lunh check (or other checksum formula) and generates a mapped credit card number, and encrypts and stores the actual credit card number and other desired credit card information into the hosted PCI database.
The customer is transferred back to the CSR, and the hosted PCI system disconnects its portion of the telephone session.
The CSR is prompted on screen with the mapped credit card number for the corresponding session ID that was initiated at the beginning of the transaction.
The CSR can then use the mapped credit card to complete the transaction, with the process and host PCI system continuing in the manner described above with respect to on-line transactions.
The CSR does not see the actual credit card number throughout the entire order taking process, and the merchant remains outside the scope of required PCI compliance.

### Method for Tokenizing Credit Card Information

In the previous descriptions of the preferred methods and systems for online and telephonic transactions, reference was made to the mapping of the actual credit card number, and the generation of a “token” that, preferably, represented the numerals between the first four and last four numerals of the actual credit card number. Attention is now directed to the preferred mapping and tokenization of the credit card number.

A credit card number is comprised of 16 digits for Visa and MasterCard and 15 digits for American Express. Those of ordinary skill in the art will recognize, however, that the preferred methodology can be easily modified to accommodate any number of groups having any number of respective digits, and the following example of a 16 digit credit card number is by way of example and not limitation.

All known tokenization and vault solutions currently map the credit card using 2 data elements. These are the actual alpha-numeric token (of any length) and a masked version of the credit card number. The masked version of the credit card number conventionally looks like this:
4640 **** **** 8312

A customer's 16 digit credit card number (the “actual credit card number”) is conventionally divided into 4 groups of 4 digits, and the following methodology is described accordingly.

During a typical on-line credit card transaction, the customer is presented with a “masked card number” wherein the middle two groups of digits are masked for security purposes; i.e., replaced by asterisks or other non-informational characters. Those of ordinary skill in the art recognize that the first four digits (i.e., the first group) simply represents the type of credit card involved; e.g., Visa, MasterCard, American Express, etc. The last four digits enable the customer to visually confirm that the correct credit card is being displayed and is to be charged. Only a system within the PCI scope has the middle two groups of digits in its database and, as will be clear below, the merchant using the system herein will accordingly not have those digits in order to remain outside the scope of PCI.

Instead of the middle two groups of digits of a customer's actual credit card number, the merchant's database will contain a middle two groups (referred to herein as a “token”) consisting of 7 assigned digits (hereinafter, “assigned digits”) and a checksum digit. Thus, for each customer credit card, the merchant's database record is the first four digits of the actual credit card number, the token (i.e., 7 assigned digits and a checksum digit) instead of the middle 8 digits, and the last four digits of the actual credit card number. This combination of digits is the “mapped credit card number”.

It will be appreciated that more than 7 or less than 7 assigned digits could be utilized; however, as will be evident from the discussion below, it is believed that the use of 7 digits will provide a number of permutations sufficient to accommodate the number of expected actual credit card numbers that must be accommodated.

From the perspective of the hosted PCI system, the preferred methodology is as follows
Each merchant on the hosted PCI system has their own unique “ID” number (the “Merchant ID”);
Both the mapped credit card number and token are represented in one data field, allowing one field to hold both the credit card token and the masked credit card number;
The hosted PCI system leaves the first 4 and last 4 digits of the credit card unchanged, allowing the merchant to display the masked credit card number to the customer by simply masking the interjacent 8-digit token of the card number (i.e., the 7 assigned digits and the 1 checksum digit) from view by the customer.
   However, even if the token is to the customer, or to any third party, there is no security risk because the token is meaningless outside of the hosted PCI system.
Preferably, the entire token provided to the merchant is a unique number that will NOT permit the mapped credit card number to pass as a valid credit card number; for example, it will fail the credit card “Luhn” test.
The use of 7 assigned digits and the checksum digit allows for a maximum of 99,999,999,999 (99 Billion) possible unique credit card numbers per merchant ID.
The mapped credit card number is determined as follows (to get to 99 Billion):
   The first 4 numbers are not used. This number is left as-is from the original credit card number, and is not used as part of the mapping algorithm.
   The 7 middle digits (the “assigned digits”) are used to create all of the possible combinations. These 7 middle digits represent the first component of the token.
   1 digit of the middle eight digits is used as a sum check digit.
   The last 4 digits of the credit card number are used to bucket sort the 7 assigned digits to increase the number of possible combinations; i.e., the mapped credit card numbers for customers having the same last four digits (hereinafter, the “first customer group”) are differentiated from each other by the assigned digits, while a second customer group having the same last four actual credit card digits as each other (but different than those of the first customer group) can be differentiated assigned the same assigned digits as the first group, and yet be distinguishable from the members of the first group, because the first and second customer groups are in separate “buckets”.
      The calculation for the total number of possible credit card tokens that can be created by the hosted PCI system in this manner is 10⁷ multiplied by 10⁴.

The foregoing methodology meets the preferred criteria of providing a mapped credit card number that includes a token that is non-Luhn compatible and that can render the mapped credit card number non Luhn-compatible as well, thereby ensuring that the mapped credit card number cannot be someone's actual credit card number. Where a merchant's system requires the mapped credit card number to be Luhn compatible, however, there are alternative methods for mapping the credit card numbers. One alternative is to suitably modify the first four digits of the actual credit card number to render the mapped credit card number Luhn-compatible, while ensuring that the mapped credit card number cannot be somebody's actual credit card number.

Ensuring that the mapped credit card number cannot be an actual credit card number after the first four digits are modified involves recognition that the first four digits conventionally represent the credit card issuer together with a bank code, as shown at length at http://en.wikipedia.org/wiki/List of Bank Identification Numbers#55 .28Mastercard.29 a printout of which is attached hereto as Attachment “A”. The content of Exhibit A is hereby incorporated by reference and made part of this specification. As shown in Attachment “A”, for example, the initial 4-digit group of a Visa® card conventionally begins with the numeral “4”. There is no bank code “111” for the subsequent three digits of the initial 4-digit group; accordingly, a suitable modification to the first four digits of a customer's actual Visa card number could be “4111”.

Consequently, a Luhn-compatible mapped credit card number beginning with “4111” can be generated to identify a customer's actual Visa card number, and the token can remain Luhn compatible if desired. Preferably, and unlike the previously described methodology, only the last four digits of the actual credit card number will be shown to the merchant (and/or to the customer). The first four digits are preferably not shown to either.

Another alternative methodology adds an additional digit to the mapped credit card number. Thus, the customer's 16-digit actual credit card number is transformed into a 17-digit mapped credit card number. The additional digit is used to render the mapped credit card number Luhn-compatible while ensuring that the mapped credit card number cannot be an actual credit card number. The first and last 4-digit groups of the actual credit card number can remain unmodified, as in the initially disclosed methodology, and can be displayed to the merchant and the customer in the same manner. However, this alternative requires a merchant system that can accept a 17-digit number, and many such systems cannot currently do so. Yet, systems accepting 15-digit credit cards (e.g., American Express), may be susceptible to receiving the extra 16^{th} digit. This alternative method can be extended to add any number of additional digits to the token.

All three of the foregoing methodologies for creating a token and a mapped credit card number maintain the important criteria of ensuring that the mapped credit card number cannot be someone's actual credit card number. Additionally, tokens can be created that are themselves non-Luhn compatible despite the fact that the actual credit card number is Luhn compatible. Moreover, algorithms other than Luhn can be accommodated as well, and the merchant remains outside the scope of PCI regardless of which methodology or algorithm is employed.

Exhibit B hereto is the preferred application programming interface (API) that a merchant can use to process credit card transactions using the preferred hosted PCI system described herein. The content of Exhibit B is hereby incorporated by reference and made part of this specification.

Exhibit C hereto is the preferred set of “front end” installation instructions advising a merchant on how to install the preferred hosted PCI system widget at the merchant's website as an I-frame. The content of Exhibit C is hereby incorporated by reference and made part of this specification

Although the present invention and its advantages have been described in detail, it should be understood that various changes, substitutions and alterations can be made herein without departing from the spirit and scope of the invention as will be defined by appended claims.

I claim:

1. In an ecommerce system wherein a purchaser uses an electronic display screen and browser to communicate with a merchant ecommerce system to purchase goods or services in a transaction that includes the use of a credit card having an actual credit card number consisting of a plurality of numerals, and wherein the actual credit card number is to be presented to a payment gateway,
a hosted PCI system for isolating the merchant ecommerce system from credit card data within the scope of PCI standards, and comprising:
a server responsive to redirected communication from the purchaser's browser initiated by the merchant ecommerce system for providing the purchaser's browser with a displayable check-out page soliciting the purchaser's actual credit card number,
said hosted PCI system receiving the purchaser's actual credit card number without said number being exposed to the merchant ecommerce system, and converting said actual credit card number into a mapped credit card number in which at least some of the numerals of the actual credit card number have been replaced by assigned numerals,
said hosted PCI system communicating the mapped credit card number to the merchant ecommerce system in lieu of the actual credit card number,
said hosted PCI system thereafter receiving data from the merchant ecommerce system including payment amount information pertaining to the purchaser's purchase together with the mapped credit card number,
the hosted PCI system then deriving the actual credit card number from the mapped credit card number received from the merchant ecommerce system and sending on behalf of the merchant the actual credit card number and payment amount information to a payment gateway from which a response is expected,
the hosted PCI system then communicating to the merchant ecommerce system the payment gateway's response without revealing the actual credit card number to the merchant ecommerce system so that the merchant can complete the purchase transaction.
